(19) United States
(12) Patent Application Publication
(10) Pub. No.: US 2026/0134572 A1
(43) Pub. Date: May 14, 2026

(54) INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventors: Makoto TOMIOKA, Kanagawa (JP); Daisuke KOTAKE, Kanagawa (JP); Hisayoshi FURIHATA, Tokyo (JP)

(21) Appl. No.: 19/382,359

(22) Filed: Nov. 7, 2025

(30) Foreign Application Priority Data
Nov. 11, 2024 (JP) 2024-196502

(51) Int. Cl. G06T 7/73

(52) U.S. Cl. CPC G06T 7/74; G06T 2207/30244

(57) ABSTRACT

An information processing system configured to set a coordinate system that is shared between a plurality of devices performs communications between a first device and a second device; acquires first image information from a first image capturing apparatus that has been provided to the first device; determines a first reference coordinate system in the first device based on the first image information; calculates first position orientation information indicating a position orientation of the first device by using the first image information and the first reference coordinate system; acquires second image information from a second image capturing apparatus that has been provided to the second device; calculates second position orientation information indicating a position orientation of the second device by using the second image information; calculates relative position orientation information indicating a relative position orientation of the first device and the second device based on the second image information and the second position orientation information; and uses the first position orientation information, the second position orientation information, and the relative position orientation information, and align the second position orientation information with the first reference coordinate system.

### BACKGROUND

### Field of the Technology

The present disclosure relates to an information processing system, an information processing method, a storage medium, and the like.

### Description of the Related Art

An MR (mixed reality) technology is known that performs a superimposed display of a virtual object (CG, writing) on a video image that has been captured by a camera. In MR, a technology is used that estimates a position orientation of a terminal (an information terminal such as a HMD, a smartphone, and the like) based on video image information, and thereby calculates a drawing position for the virtual object that has been made to match the movements of the terminal.

In order to draw a virtual object, a coordinate system that will become an origin point somewhere in a three-dimensional space (referred to below as a reference coordinate system) is necessary. In MR applications that use markers, there are many cases in which the reference coordinate system is set at the marker position.

In addition, in recent years, as is shown in non-patent publication 1 (C. Campos, R. Elvira, J. J. G. Rodriguez, J. M. Montiel, and J. D. Tardos, ORB-SLAM3: An Accurate Open-Source Library for Visual, Visual-Inertial, and Multi-Map SLAM, IEEE Transactions on Robotics 37 (6), December 2021.), a SLAM (Simultaneous Localization and Mapping) technology that does not need markers is spreading as a method for estimating a position orientation of a terminal.

In addition, there are many cases in which the reference coordinate system is set on a flat surface such as a floor, or a desk in the three-dimensional space, cases in which the reference coordinate system is set to an initial position of the camera, and cases in which the reference coordinate system is set to an arbitrary position according to an input from the user. Note that non-patent publication 2 (Parallel Tracking and Mapping for Small AR Workspaces, Klein. Et. Al, ISMAR 2007) discloses an example of a method for determining the reference coordinates. In addition, a position orientation estimating method for an object based on model fitting is generally known.

However, in the prior art, in a case in which markers are not used, and a plurality of users want to experience the MR using their own individual terminals, if each terminal sets separate reference coordinate systems, the virtual object will be displayed in different positions in the physical space for each terminal.

### SUMMARY

One embodiment of the present disclosure is an information processing system configured to align a coordinate system that is shared between a plurality of devices, the information processing system comprising: at least one processor, and a memory coupled to the at least one processor, the memory storing instructions that, when executed by the at least one processor, cause the at least one processor to: perform communications between a first device and a second device; acquire first image information from a first image capturing apparatus that has been provided to the first device; determine a first reference coordinate system in the first device based on the first image information; calculate first position orientation information indicating a position orientation of the first device by using the first image information and the first reference coordinate system; acquire second image information from a second image capturing apparatus that has been provided to the second device; calculate second position orientation information indicating a position orientation of the second device by using the second image information; calculate relative position orientation information indicating a relative position orientation of the first device and the second device based on the second image information and the second position orientation information; and use the first position orientation information, the second position orientation information, and the relative position orientation information, and align the second position orientation information with the first reference coordinate system.

Further features of the present disclosure will become apparent from the following description of embodiments with reference to the attached drawings.

### BRIEF DESCRIPTION OF THE DRAWINGS

FIG. 1 is a diagram explaining an example of a relationship between a usage state and coordinates of an information processing system 1 of a First Embodiment of the present disclosure.

FIG. 2 is a block diagram showing a hardware configuration example of the information processing system 1 of the First Embodiment.

FIG. 3 is a functional block diagram explaining a configurational example of the information processing system 1 of the First Embodiment.

FIG. 4 is a flowchart showing a processing example for an information processing method using the information processing system 1 of the First Embodiment.

FIG. 5 is a functional block diagram showing a configurational example of an information processing system of a Second Embodiment.

FIG. 6 is a flowchart showing a processing example for an information processing method using the information processing system of the Second Embodiment.

FIG. 7 is a functional block diagram showing a configurational example of an information processing system of a Third Embodiment.

FIG. 8A is a flowchart showing a processing example for an information processing method using the information processing system of the Third Embodiment.

FIG. 8B is a flowchart that is a continuation of FIG. 8A.

FIG. 8C is a flowchart that is a continuation of FIG. 8B.

FIG. 9 is a diagram showing an example of a GUI that is displayed by the information processing system of the Third Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

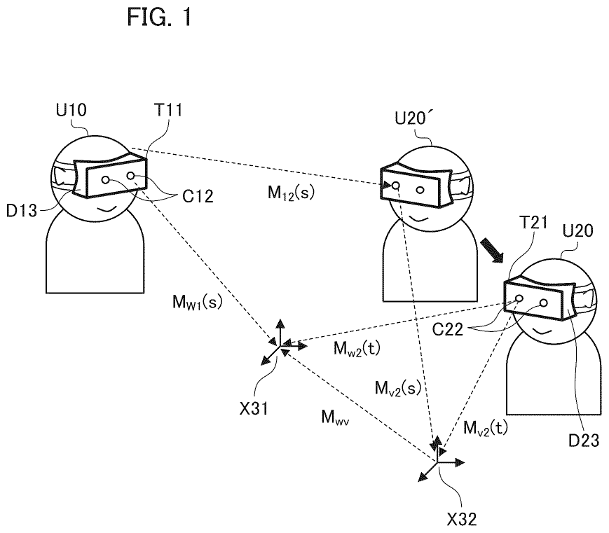

In the present embodiment, a usage case in which one reference coordinate system is shared by two terminals will be explained. FIG. 1 is a diagram explaining an example of a relationship between a state of use and coordinates of the information processing system 1 of the First Embodiment of the present disclosure, and shows the relationship between two users and two terminals. Note that the information processing system of the present embodiment is configured so as to be able to align a shared coordinate system on a plurality of devices.

In FIGS. 1, U10 and U20 are users who are attempting to experience the MR. T11 is the terminal that the user U10 is equipped with and T21 is the terminal that the user U20 is equipped with, and in the present embodiment, the terminals are HMDs (head mount displays). Note that the terminal T11 corresponds to a first terminal or a first device and the terminal T21 corresponds to a second terminal or a second device. In the following embodiments, a terminal may be referred to as a device.

C21 is an image capturing apparatus that has been built into the terminal T11, and C22 is an image capturing apparatus that has been built into the terminal T21, that is, C21 and C22 are cameras, and calculate the position orientation information for each terminal from the surrounding scenery by using a SLAM technology. D13 is a display that has been built into the terminal T11, and D23 is a display that has been built into the terminal T21, and the users see virtual objects that have been displayed on these displays. X31 is a reference coordinate system that has been set in the terminal T11 (a first reference coordinate system), and is an origin point for displaying the virtual objects.

In the present embodiment, position orientation information (Mw2(t) in the diagrams) for the terminal T21 at a time t at which the camera C22 captured an image is calculated in relation to the reference coordinate system X31 in order for the terminal T21 to draw the same virtual object as the terminal T11.

Note that the position orientation in the present embodiment is information for six degrees of freedom showing a mechanical relationship between two objects, and for example, is represented by a 4× 4 matrix.

The terminal T11 and the terminal T21 are independent devices, and therefore, although the terminal T21 can use a reference coordinate system X32 (a second reference coordinate system) that the terminal T21 references, the terminal T21 cannot use the reference coordinate system X31 for the terminal T11.

That is, the terminal T21 is only able to calculate position orientation information in relation to the reference coordinate system X32 (Mv2(t) in the diagrams). However, in the present embodiment, the terminal T21 finds Mw2(t) using a matrix operation such as the Formula 1 below by storing the relative position orientation information (Mwv in the diagrams) between the reference coordinate system X31 and the reference coordinate system X32 for the terminal T21.

$${M}_{w 2 ( t )} = {M}_{wv} {M}_{v 2 ( t )} \qquad Formula ( 1 )$$

U20′ represents the position of the user U20 at a specific time s. In this context, the position orientation information for the terminal T11 in the first reference coordinate system X31 that has been measured at the time s is made Mw1(s), the position orientation information for the terminal T21 in the second reference coordinate system X32 that has been measured at the time s is made Mv2(s), and the relative position orientation information for the terminal T11 and the terminal T21 that has been measured during the time period s is made M12(s). In this case, Mwv can be calculated using a matrix calculation such as the following Formula 2. Note that the superscript −1 in the Formula 2 indicates that this is an inverse matrix.

$${M}_{wv} = {M}_{w 1 ( s )} {M}_{12 ( s )} {M}_{v 2 ( s )}^{- 1} \qquad ( Formula 2 )$$

In the present embodiment, the reference coordinate systems are standardized and used in a plurality of different terminals by operations such as those shown in the above Formula 1, and Formula 2. In addition, the information for standardizing the reference coordinates is mutually transmitted and received by communications units in each of the terminals.

Note that in the present embodiment, the position orientation information is six degrees of freedom showing a mechanical relationship between two objects, as was described above, and in a case in which the position orientation information for a terminal is being indicated, it is sufficient if it is understood what position and what orientation the terminal has in the space. In the present embodiment, the position orientation information is made the position orientation information for the built-in cameras.

However, the present disclosure is not limited thereto, and for example, the position orientation information may also be the position orientation information for the centers of gravity of the terminals, and may also be the position orientation information for the central portions of the displays (mutual conversion is possible if the coordinate relationship within the terminal is already known). The time s and the time t are times at which the image capturing apparatuses (cameras) of the terminals have captured images of image information, and in the present embodiment, UNIX time is used.

In addition, unless otherwise noted, the time tis an arbitrary time at which image information was image captured, that is, the time t indicates the time at which the position orientation for the terminal is calculated. The time s indicates the time that is used when making the reference coordinate systems for the first terminal (the terminal T11), and the second terminal (the terminal T21) match.

That is, this indicates that image information that was captured at the same time is used in the first terminal and the second terminal. Note that the time s does not strictly indicate the time at which the coordinate systems were made to match, and calculation errors are permitted to some extent.

Note that the shape model in the present embodiment is written in an SLT (standard tessellation language) file format. SLT is a file that writes the surface geometry of 3D models and objects, and is a file that is configured by connecting triangles. However, the file format is not limited thereto.

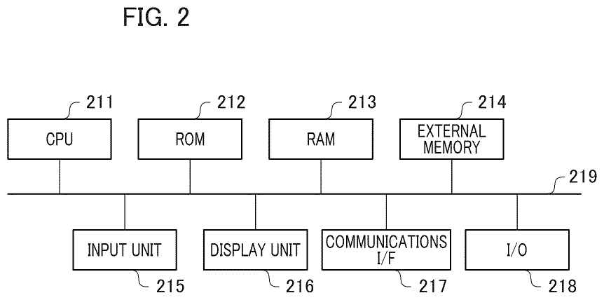

FIG. 2 is a block diagram showing a hardware configuration example of the information processing system 1 of the First Embodiment. 211 is a CPU that serves as a computer, and performs control of each type of device that has been connected to a system bus 219. 212 is a ROM, and stores BIOS programs and boot programs.

213 is a RAM, and is used as the primary storage apparatus for the CPU 211. 214 is an external memory, and stores a computer system that operates the information processing system 1. 215 is an input unit that receives input from a keyboard and mouse, and a touch panel, and performs processing according to the input of information and the like.

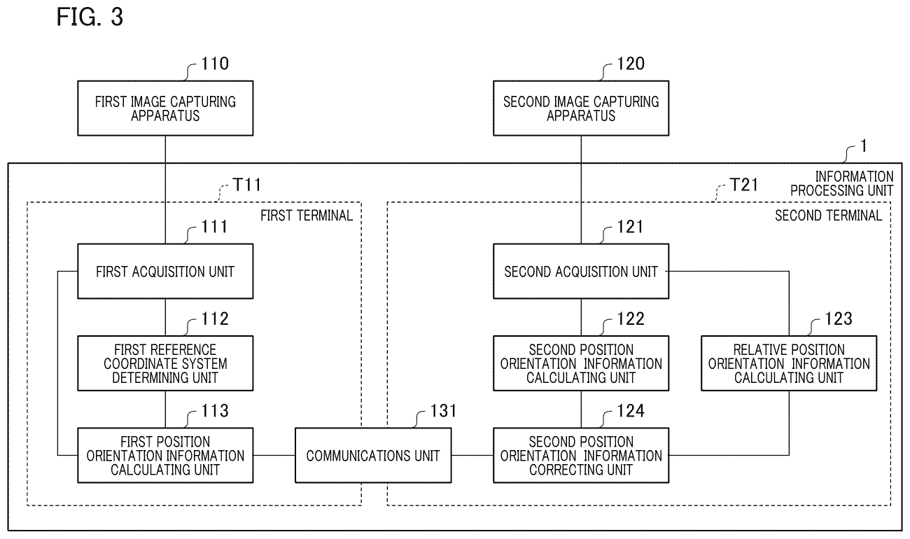

216 is a display unit, and outputs video image information to a display with which the terminal is equipped. 217 is a communications I/F and communicates information with different terminals. 218 is an I/O, and acquires video images from a camera that the terminal is provided with. Note that in the present embodiment, it is made such that there are two terminals, and each terminal has the hardware that is shown in FIG. 3, and transmits and receives information via the communications I/F 217.

FIG. 3 is a functional block diagram that explains a configuration example of the information processing system 1 of the First Embodiment, and the information processing system 1 comprises the first terminal T11, and the second terminal T21.

Note that a portion of the functional blocks that are shown in FIG. 3 are realized by the CPU 211 and the like that serves as a computer and is included in the information processing system executing a computer program that has been stored on a memory that serves as a storage medium.

However, a portion or the entire of these blocks may also be made so as to be realized by hardware. An application specific integrated circuit (ASIC), a processor (reconfiguration processor, DSP), and the like can be used as the hardware.

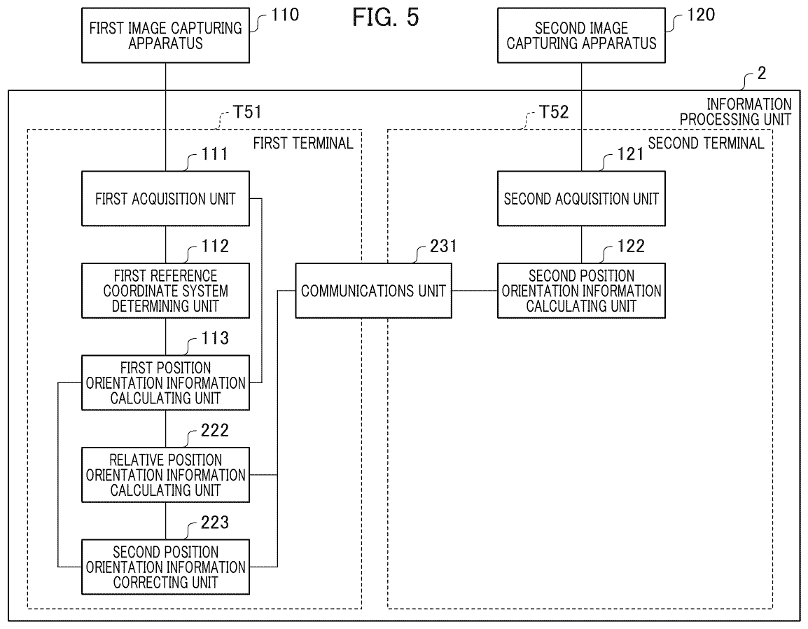

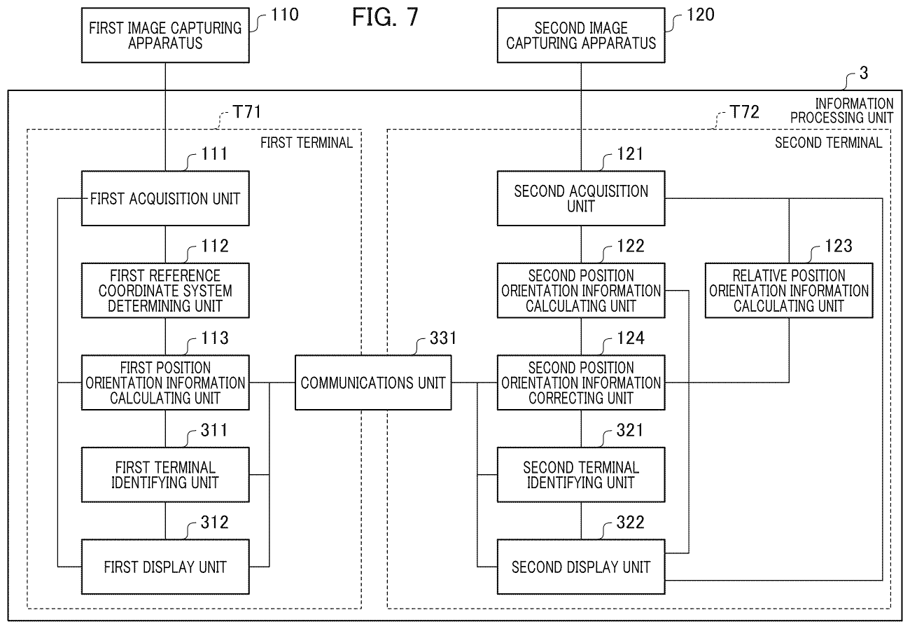

In addition, each of the functional blocks that is shown in FIG. 3 does not need to be housed in the same body, and they may also be configured by separate apparatuses that have been connected to each other via a signal path. In addition, at least one portion of the functions of the information processing system 1 may also be provided by an external server, and the like. Note that the above explanation in relation to FIG. 3 also applies in the same manner to FIG. 5, and FIG. 7.

A first image capturing apparatus 110 is a camera that corresponds to C12 of FIG. 1, and a second image capturing apparatus 120 is a camera that corresponds to C22 of FIG. 1. The information processing system 1 uses first image information that has been captured by the first image capturing apparatus 110 and calculates position orientation information for the first terminal T11 in a standard reference coordinate system, and uses second image information that has been captured by the second image capturing apparatus 120 and calculates position orientation information for the second terminal T21 in a standard reference coordinate system.

In the present embodiment, a configuration will be explained in which the second terminal T21 corrects the second terminal position orientation information (Mv2(t)) in the second reference coordinate system X32 to position orientation information (Mw2(t)) in the first reference coordinate system X31. Note that in the present embodiment, the first information terminal and the second information terminal are made the same shape, and each terminal stores a shape model of itself in a storage unit that is not shown.

A first acquisition unit 111 is built into the first terminal T11, first image information is input to the first acquisition unit 111 from the first image capturing apparatus 110, and the first acquisition unit 111 outputs the first image information that has been input to a first reference coordinate system determining unit 112 and a first position orientation information calculating unit 113. Note that the first acquisition unit 111 functions as a first acquisition unit configured to acquire first image information from a first image capturing apparatus that has been provided to the first terminal.

The first reference coordinate determining unit 112 is built into the first terminal T11, and determines the first reference coordinate system X31 that indicates the origin point in the calculation of the position orientation based on the first image information that has been input by the first acquisition unit 111.

The first reference coordinate system determining unit 112 outputs the first reference coordinate system X31 to the first position orientation information calculating unit 113. The first reference coordinate system determining unit 112 functions as a first reference coordinate system determining unit configured to determine the first reference coordinate system in the first terminal based on the first image information.

The first position orientation information calculating unit 113 is built-into the first terminal T11, uses the first reference coordinate system X31 that has been calculated by the first reference coordinate system determining unit 112, and calculates position orientation information for the first terminal in relation to the first reference coordinate system X31 (first position orientation information).

Note that the first position orientation information calculating unit 113 functions as a first position orientation information calculating unit configured to calculate first position orientation information that indicates the position orientation of the first terminal by using the first image information and the first reference coordinate system.

Note that the first position orientation information is the Mw1(s) that was explained in FIG. 1. The first position orientation information calculating unit 113 outputs the first position orientation information Mw1(s) that has been calculated to a communications unit 131.

Each of the first terminal T11 and the second terminal T21 have built in communications units 131, and these are wireless network modules that serve as a communications unit for performing communications between the first terminal T11 and the second terminal T21. The communications unit 131 transmits the first position orientation information Mw1(s) that was calculated by the first position orientation information calculating unit 113 to the second terminal via a wireless network.

In contrast, a second acquisition unit 121 inputs the image information that has been image captured by the second image capturing apparatus 120. The second acquisition unit 121 inputs the image that has been input to a second position orientation information calculating unit 122 and a relative position orientation information calculating unit 123. Note that the second acquisition unit 121 functions as a second acquisition unit configured to acquire second image information from the second image capturing apparatus that has been provided to the second terminal.

The second position orientation information calculating unit 122 uses the second image information that has been input by the second acquisition unit 121 and calculates the position orientation information for the second terminal T21. Note that in the present embodiment, it is made such that the position orientation information for the second terminal (second position orientation information) in the reference coordinate system, in which the coordinates from when the second terminal was started up are made the origin point, is calculated as the reference coordinate system for the second terminal T21.

Note that the second position orientation information calculating unit 122 functions as a second position orientation information calculating unit configured to calculate second position orientation information indicating a position orientation of the second terminal by using the second image information.

Note that as is shown in FIG. 1, the notation for the second position orientation information that was calculated during the time s is Mv2(s) (in addition, the notation for the second position orientation information that was calculated during the time t is Mv2(t)). The second position orientation information calculating unit 122 outputs the second position orientation information that has been calculated to a second position orientation information correcting unit 124.

The relative position orientation information calculating unit 123 calculates the relative position orientation information for the first terminal T11 and the second terminal T21 based on the image of the first terminal that is shown in the second image information that has been input from the second acquisition unit 121.

Note that the relative position orientation information calculating unit 123 functions as a relative position orientation calculating unit configured to calculate relative position orientation information indicating the relative position orientation of the first terminal and the second terminal based on the second image information and the second position orientation information.

Note that the relative position orientation information in this context is M12(s) that is shown in FIG. 1. The relative position orientation information calculating unit 123 outputs the relative position orientation information M12(s) that has been calculated to the second position orientation information correcting unit 124.

The second position orientation information correcting unit 124 uses the first position orientation information Mw1(s) for the first terminal T11, the second position orientation information Mv2(s), and the relative position orientation information M12(s) and calculates second position orientation information in the first reference coordinate system X31. Note that the second position orientation information corresponds to Mw2(t) in FIG. 1.

Note that the second position orientation information correcting unit 124 functions as a second position orientation information aligning unit configured to use the first position orientation information, the second position orientation information, and the relative position orientation information and align the second position orientation information with the first reference coordinate system.

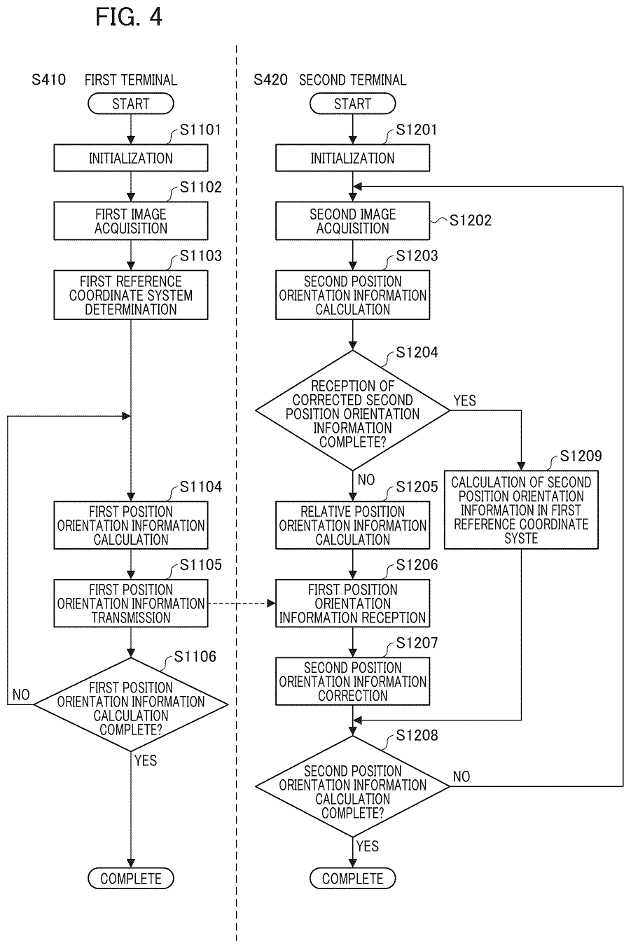

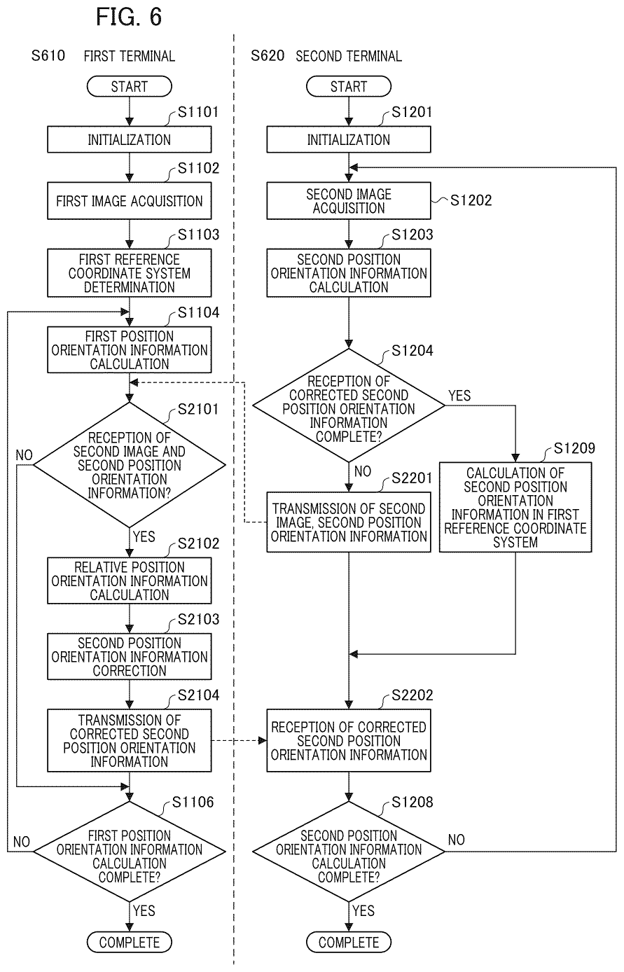

FIG. 4 is a flowchart showing a processing example for an information processing method using the information processing system 1 according to the First Embodiment. Note that the operations for each step of the flowchart in FIG. 6 are performed in order by the CPUs and the like that have been provided as computers in each of the first terminal and the second terminal executing a computer program that has been stored on a memory. Note that a coordinate system that is shared by a plurality of devices is aligned by the information processing method of the present embodiment.

Step S410 is processing that is executed in the first terminal T11 and step S420 is processing that is executed in the second terminal T21. Each processing in step S410 is begun in accordance with the power source for the first terminal T11 being turned on. In addition, step S420 is begun in accordance with the power source for the second terminal T21 being turned on.

Note that the processing order shown in the flowchart in the following explanation does not limit the present disclosure to the example that is shown in the flowchart. In addition, it is also possible for each processing in the flowchart to be individually extracted and thereby function as independent functional elements, and to be used by being combined with processing other than the processing that is shown.

During step S1101, initialization is performed for the system of the module according to the first terminal T11 of the information processing system 1. That is, the CPU 211 reads a program from the external memory 214, and creates a state in which the terminal T11 is operable.

In addition, camera parameters and communications profiles are read onto the RAM 213 from the external memory 214 as needed. If the series of initialization processing is completed, the processing transitions to step S1102.

During step S1102, the first acquisition unit 111 acquires the first image that has been captured by the first image capturing apparatus 110. In this context, step S1102 functions as a first acquisition step for acquiring first image information from the first image capturing apparatus that has been provided to the first terminal.

In addition, the first image that has been acquired is output to the first reference coordinate system determining unit 112, and the first position orientation information calculating unit 113, and the processing transitions to step S1103.

During step S1103, the first reference coordinate system determining unit 112 detects a flat surface from the first image information, and determines the first reference coordinate system X31 by making arbitrary coordinates on the flat surface the origin point. In this context, step S1103 functions as a first reference coordinate system determining step for determining the first reference coordinate system in the first terminal based on the first image information.

Note that it is sufficient if the method that has been disclosed in non-patent publication 2 is used as the determination method for the reference coordinates. If the first reference coordinate system X31 has been set, the processing transitions to step S1104.

During step S1104, the first position orientation information calculating unit 113 calculates the first position orientation information Mw1(s) in relation to the first reference coordinate system X31. In this context, step S1104 functions as a first position orientation information calculating step for calculating a first position orientation that indicates the position orientation of the first terminal by using the first image information and the reference coordinate system.

SLAM is used in the position orientation calculation. Specifically, feature points are detected from the image information that has been input, and three-dimensional map information for the feature points is created in relation to the first reference coordinate system X31. Note that for example, the first position orientation information calculating unit 113 has a map information storage unit configured to store map information for calculating the second position orientation information.

The features points are singularities in the image such as angles and the like, and are indices such that it is possible find corresponding relationships between the images. The three-dimensional map information is map data in which the three-dimensional positions of the features points have been stored.

The position orientation for which the appearance most matches the feature points that have been detected from this map information and the first image information, that is, the position orientation with the smallest re-projection error, is calculated. Such a SLAM configuration is disclosed in the above-described non-patent publication 2, and this is cited. If the first position orientation information Mw1(s) has been calculated, the processing transitions to step S1105.

During step S1105, the communications unit 131 transmits the first position orientation information Mw1(s) via, for example, a wireless network. That is, the communication unit transmits the first position orientation information from the first terminal to the second terminal. In this context, step S1105 functions as a communications step for performing communications between the first terminal and the second terminal.

In the present embodiment, the first position orientation information Mw1(s) is transmitted to terminals in the vicinity of the first terminal T11 by being broadcasted. If the transmission is completed, the processing transitions to step S1106.

During step S1106, it is determined whether or not the calculation of the first position orientation information has been completed. That is, a determining unit that is not shown determines whether or not the calculation of the first position orientation information Mw1(s) has been completed in the first terminal T11.

In a case in which it has been determined that a completion flag for completing the use of the HMD has been input by the user using an input unit that is not shown, the processing flow for the FIG. 4 is completed, and if this is not the case, the processing returns to step S1104, and the calculations for the first position orientation information Mw1(s) are repeated.

During step S1201, the initialization processing is performed for the system of the module according to the second terminal T21 of the information processing system 1. In the same manner as in step S1101, the CPU 211 reads a program from the external memory 214 and creates a state in which the terminal T21 is operable. In addition, camera parameters and communications profiles are read onto the RAM 213 from the external memory 214 as necessary. If the series of initialization processing is completed, the processing transitions to step S1202.

During step S1202, the second acquisition unit 121 acquires the second image information that has been captured by the second image capturing apparatus 120. In this context, step S1202 functions as a second acquisition step for acquiring second image information from a second image capturing apparatus that has been provided to a second terminal. In addition, the second image information that has been acquired is input into the second position orientation information calculating unit 122, and the relative position orientation information calculating unit 123, and the processing transitions to step S1203.

During step S1203, the second position orientation information acquisition unit 122 detects the second position orientation information in the second reference coordinate system X32. That is, the second position orientation information calculating unit 122 calculates the Mv2(s) of FIG. 1. In this context, step S1203 functions as a second position orientation information calculating step for calculating second position orientation information indicating the position orientation of the second terminal by using the second image information. Note that in the present embodiment, it is made such that in the second reference coordinate system X32, the position orientation at the time at which the second terminal T21 is started up is the origin point.

In addition, s is the time at which the second image information has been image captured. The position orientation information calculation uses SLAM, and the method that has been disclosed in non-patent publication 2 is used. Note that in the present embodiment, it is made such that the map information using SLAM that has been described above is individually generated in each of the terminals of the first terminal T11, and the second terminal T21. That is, pieces of map information that have been created in different reference coordinate systems are used. If the second position orientation information Mv2(s) has been calculated, the processing transitions to step S1204.

During step S1204, it is determined whether or not the corrected second position orientation information has been received. That is, the second position orientation information calculating unit 122 determines whether or not the second position orientation information MvS(2) has been corrected by being made to match the first reference coordinate system X31.

Specifically, it is determined that the second position orientation information Mv2(s) has been corrected by being made to match the first reference coordinate system X31 if it has been possible to calculate the relative position orientation information Mwv for the first terminal T11 in the reference coordinate system X31 and the second terminal T21 in the reference coordinate system X32. In addition, if this is the case, the processing proceeds to step S1209, and if this is not the case, the processing proceeds to step S1205.

During step S1205, the relative position orientation information calculating unit 123 calculates the relative position orientation information M12(s) for the first terminal T11 and the second terminal T21. In this context, step S1205 functions as a relative position orientation information calculating step for calculating relative position orientation information indicating a relative position orientation of the first terminal and the second terminal based on the second image information and the second position orientation information.

The calculation of the relative position orientation information M12(s) is performed by model fitting the second image information with a shape model (CAD data) for the first terminal T11 that is stored on the storage unit, which is not shown, inside of the second terminal.

Note that it is sufficient if the method that has been disclosed in non-patent publication 3 is used as the object position orientation estimating method based on model fitting.

By doing so, if the relative position orientation information M12(s) has been calculated for the first terminal T11 and the second terminal T21, the processing transitions to step S1206. During step S1206, the first position orientation information Mw1(s) is acquired from the first terminal T11 via the communications unit 131. After this, the processing transitions to step S1207.

During step S1207, the second position orientation information is corrected. That is, the second position orientation information correcting unit 124 calculates the relative position orientation information Mwv for between the first reference coordinate system X31, and the second reference coordinate system X32. That is, during step S1207, the relative position orientation information calculating unit calculates the relative position orientation information by using the first position orientation information that has been received by the communications unit.

Specifically, the Mv2(s) and M12(s) that have been calculated in the second terminal, and the Mw1(s) that has been received from the first terminal are used, and the relative position orientation information Mwv for between the reference coordinate systems is calculated using the previously explained Formula 2. In addition, the second position orientation information is corrected by calculating the second position orientation information Mw2(t) for the first reference coordinate system X31 by using the Formula 1. After this, the processing transitions to step S1208.

In this context, step S1207 functions as a second position orientation information aligning step for aligning the second position orientation information with the first reference coordinate system using the first position orientation information, the second position orientation information, and the relative position orientation information.

During step S1208, the determining unit, which is not shown, determines whether or not to complete the calculation (correction) of the second position orientation information. In a case in which the user has used the input unit, which is not shown, to perform an operation for ending use of the terminal T21, and a completion flag has been input, the flow for the processing of FIG. 4 is completed, and if this is not the case, the processing returns to S1202, and the position orientation calculation for the second terminal T21 is repeated.

In contrast, during step S1209, the second position orientation information is calculated (corrected) in the first reference coordinate system X31. That is, the second position orientation information calculating unit 122 uses the relative position orientation information Mwv for between the reference coordinate systems, and converts Mv2(t), which is the second position orientation information that was calculated by the second position orientation information calculating unit 122 at a specific time t, to the second position orientation information Mw2(t) for the first reference coordinate system X31.

That is, the second position orientation information is corrected by calculating Mw2(t) by using the previously explained Formula 1.

In this manner, the position orientation information that has been calculated in the first terminal is transmitted to the second terminal via the communications unit. In addition, by converting the coordinates such that reference coordinate systems are corrected by using the information that has been transmitted in the second terminal, it is possible to realize position orientation calculation in a reference coordinate system that is standard with the first terminal even in a different terminal. Therefore, it is possible to display a virtual object in the same position in a physical space in a plurality of terminals or a plurality of devices.

### Variation Examples for the First Embodiment

Although in the First Embodiment, the communications unit 131 broadcasted the first position orientation information Mw1(s) from the first terminal T11, it may also be made such that a connection is established between the first terminal and the second terminal in advance, and two-way communications such as TCP/IP are performed. By doing so, it becomes possible to correct mistakes and re-send information for communications errors, and it is possible to standardize the reference coordinate systems in a more stable manner.

In addition, although a configuration has been explained for the communications unit 131 in which the first terminal T11 and the second terminal T21 directly receive and transmit information, the information may also be transmitted and received via a router, and a separate server that is not shown. In addition, this may also be a configuration in which the communications unit 131 transmits the necessary information to the server, and the server calculates and transmits the reference coordinate system to each terminal. By doing so, it is no longer necessary to perform standardization processing for the reference coordinate systems in each terminal, and it is possible to use a standard reference coordinate system.

Note that although the communications unit 131 in the First Embodiment described above transmits the first position orientation information Mw1(s), the contents of the communication are not limited to the position orientation information, and additional information in order to calculate the reference coordinate system with a high degree of precision may also be transmitted.

For example, time information for the images that were used in the calculation of the position orientation may also be combined and transmitted. By doing so, it is possible to select the position orientation information that is close to the time s for the image for which the relative position orientation information M12(s) is calculated for the first and second terminals from among a time series first position orientation information group Mw1(r) (the time r indicates a plurality of times) that has been received by the second terminal T21.

That is, by using data that is ≈s, it is possible to standardize the reference coordinate systems by using the position orientation information for terminals for times that are close to each other, and it is possible to standardize the reference coordinate systems with a greater degree of precision.

Furthermore, a signal for synchronizing the time information for both of the terminals may also be transmitted. That is, the communications unit may also synchronize the time for the first terminal and the second terminal by transmitting time information for the first terminal and the second terminal. For example, this may also be a configuration such that the first terminal internally stores an ntp server, and the second terminal performs time synchronization via the communications unit 131.

In addition, the first acquisition unit may also associate the image capturing time at which the first image information was captured with the first image information, and the second acquisition unit may also associate the image capturing time at which the second image information was captured with the second image information, and further input these. Furthermore, the first position orientation information calculating unit, the second position orientation information calculating unit, and the relative position orientation information calculating unit may also associate and store the times at which the first image information and the second image information were image captured.

By doing so, it is possible to select the position orientation information that is used in order to standardize the reference coordinate system by using time information that has been synchronized with a higher degree of precision, and therefore, it is possible to standardize the reference coordinate system with a higher degree of precision.

Note that the first position orientation information calculating unit may also calculate first position orientation information for each image for each time, the second position orientation information calculating unit may also calculate second position orientation information for each image for each time, and the relative position orientation information calculating unit may also calculate relative position orientation information for each image for each time.

That is, first position orientation information, second position orientation information, and relative position orientation information may all be calculated for each image for each time by using the first image information and the second image information, which have been captured at a plurality of times.

In addition, the second position orientation information aligning unit may also select, from among the first position orientation information, the second position orientation information, and the relative position orientation information, which have all been calculated at a plurality of times, a first position orientation information, a second position orientation information, and a relative position orientation information for which the difference in the image capturing times that have been associated therewith are less than a predetermined value. In addition, the second position orientation information may also be aligned with the first reference coordinate system based on each piece of position orientation information that has been selected.

In addition, in the present embodiment, it is assumed that the two terminals (HMDs) have the same shape. However, if shape models for terminals that are targets for the standardization of the reference coordinate systems are stored in advance on the storage unit, which is not shown, and received from the internet, the separate server that is not shown, and a terminal, then it is also possible to handle cases in which the shapes are different.

In addition, if each terminal has stored the shape model for itself, the communications unit 131 may also transmit these shape models. That is, the communications unit may also transmit a shape model for the first terminal, which is stored by the first terminal, to the second terminal from the first terminal.

In addition, for example, the relative position orientation information calculating unit with which the second terminal has been provided may also calculate the relative position orientation information by performing model fitting by using the shape model for the first terminal that has been received via the communications unit. By doing so, it is possible to acquire the shape model from a different terminal via the communications unit 131 even if the shape model for a different terminal that is calculated from the image is not stored.

In addition, in the above-described embodiment, the reference coordinate system was set on the plane by the first reference coordinate system determining unit 112 detecting the plane. However, the present disclosure is not limited to the above-described method as long as a method is used that is able to determine an origin point in a space. That is, the coordinates from when the terminal was started up may be made the reference coordinate system, and an object that has been allocated a specific shape and pattern may also be detected from the image information and thereby made the reference coordinate system. In addition, a point that has been allocated a predetermined offset from these may also be made the reference coordinate system.

In addition, although in the present embodiment, a configuration has been explained in which the second reference coordinate system X32 is also calculated in the second terminal, the present disclosure may also be realized without calculating the second reference coordinate system X32. That is, it may also be made such that after the information for setting the first reference coordinate system X31 has been transmitted via the communications unit from the first terminal T11, the second position orientation information is calculated for this reference coordinate system.

In addition, in the present embodiment, the second position orientation information Mv2(t) in the second reference coordinate system X32 was converted to the second position orientation information Mw2(t) for the first reference coordinate system X31 by using the Formula 1. However, the present disclosure may also be realized using a configuration such that instead of correcting the position orientation information, the coordinates for the SLAM map are corrected.

That is, the map information may also be overwritten by multiplying the coordinates for each element of the feature points for the map information by Mvw (the inverse matrix of Mwv) so as to correct the relative position orientation information Mwv for among the reference coordinate systems that was calculated during step S1207.

That is, the second position orientation information aligning unit may also align the coordinates for each element of the map information such that this becomes the first reference coordinate system when aligning the second position orientation information with the first reference coordinate system.

By doing so, the coordinates that are calculated by step S1203 become the reference coordinate system of the first terminal, and therefore, it is possible to standardize the reference coordinate systems without the processing for step S1209, that is, without the first calculation.

In addition, although the image capturing apparatus in the present embodiment is a camera, the camera may also be a camera that is able to acquire color images by using an RGB color filter, and the camera may also be a camera that acquires gray images. That is, it is sufficient if the image capturing apparatus is able to obtain images such that the position orientation information for the terminal can be calculated, and for example, this may also be a depth camera that acquires depth information.

Furthermore, the image capturing apparatus may also use a sensor apparatus that acquires the shape of the surroundings such as LiDAR (Light Detection and Ranging) instead of a camera.

In addition, although an STL format has been used for the shape model, a PLY (polygon file format) such as a point cloud may also be used as long as it is possible to calculate the position orientation information using model fitting from the image information.

In addition, the relative position orientation information calculating unit 123 calculated the relative position orientation information M12(s) by using the shape model of the terminal. However, the present disclosure is not limited thereto, and if the terminal is provided with a marker (for example, an AR marker), an LED array, and the like such that is possible to calculate the position orientation of the terminal, the relative position orientation may also be calculated by detecting these markers. That is, the shape model in the present embodiment includes markers, LED arrays, and the like such as those described above.

In such a case, the communications unit 131 may also transmit this information for specifying the terminal. In addition, the communications unit 131 may also transmit how the terminal will be specified, and the method and software that are specified. That is, the first terminal has a first terminal identification unit that identifies the first terminal, and the communication unit may also transmit the shape model for the first terminal in order to identify the first terminal based on the second image information.

In addition, the first terminal identification unit may also be made to identify the first terminal by using the shape model for the first terminal and identifying the first terminal from the second image information.

In the present embodiment, a method has been explained in which the reference coordinate systems are standardized at a specific time s. However, it is also possible to standardize the reference coordinate systems based on information that is acquired at a plurality of times, and to standardize the reference coordinate systems with a higher degree of precision by using the average and median values for these. In such a configuration, the communications unit 131 transmits the position orientation information for a plurality of times, and it is possible to store these in each terminal.

In the present embodiment, the second position orientation information Mv2(t) for the second terminal T21 was corrected so as to match the reference coordinate system in the first terminal T11. However, the roles of the first terminal T11 and the second terminal T21 may also be switched.

That is, this is a configuration in which one of these two terminals is made to operate as the first terminal T11 and the other is made to operate as the second terminal T21. In such a configuration, the present disclosure is able to be realized by the communications terminal 131 transmitting and receiving information that determines a representative terminal (the terminal that will set the reference coordinate system).

For example, this is a configuration in which the two terminals each calculate a numerical value based on a random number, and the terminal that has calculated the larger number is made the first terminal (the representative terminal). In addition, the terminal for which the degree of precision for the position orientation detection and the degree of stability for the position orientation detection are higher may also be made the representative terminal.

Having a high degree of precision for position orientation detection refers to, for example, a re-projection error value in the SLAM being small, and a residual for optimization processing during the position orientation calculation being small. In addition, the degree of stability for the position orientation detection being high refers to the amount of feature points being used in the SLAM being high, and the luminance variations in the image information being small.

The representative terminal may also be set by the communications unit 131 transmitting this information (the position orientation detection degree of precision information and the position orientation detection degree of stability information). By doing so, it is possible to standardize the reference coordinate systems using the terminal that performs calculations with a higher degree of precision as the reference.

Both of the first terminal T11 and the second terminal T21 may also store the configurations that have been explained in the present embodiment, both calculate the relative position orientation information M12(s), and standardize the reference coordinate systems by integrating these two pieces of relative position orientation information M12(s).

The communications unit 131 may also exchange the information that is necessary for the two terminals to calculate the position orientation information. By doing so, it is possible to standardize the reference coordinate systems with a higher precision.

In addition, when calculating the relative position orientation information M12(s), if the image obtained by the first terminal T11 includes an vignetting or the like by an obstacle and the like in the second image information, information (guidance) so as to move the terminal may also be provided to the user who is using the first terminal T11 and the second terminal T21 so that the image obtained by the first terminal T11 does not have the vignatting In addition, the communications unit 131 may also exchange such information. By doing so, it is possible to standardize the reference coordinate system with a higher degree of precision.

### Second Embodiment

In the First Embodiment, the second terminal received information for standardizing the reference coordinate systems from the first terminal, and corrected the second position orientation information. In the Second Embodiment, an explanation will be given of an example in which the first terminal is image captured in the second terminal, this image is transmitted to the first terminal, and the first terminal, which has received this image, corrects the second position orientation information.

That is, the first terminal uses image information for the first terminal that was image captured by a different terminal and the shape model that is stored by the first terminal itself, calculates the relative position orientation information for between the terminals, uses this relative position orientation information, and standardizes the reference coordinate systems.

FIG. 5 is a functional block diagram showing an example of a configuration for the information processing system of the Second Embodiment. The configurations that are the same as the configurations in the First Embodiment have been notated using the same numbers, and explanations thereof will be omitted. An information processing system 2 comprises a first terminal T51 and a second terminal T52.

The differences with the First Embodiment are the point that a relative position orientation information calculating unit 222 and a second position orientation information correcting unit 223 are built into the first terminal T51, and the point that the information that is transmitted and received by a communications unit 231 changes.

The communications unit 231 is built into the first terminal T51 and the second terminal T52. The second position orientation information (MV2(s) from FIG. 1) that was calculated by the second position orientation information calculating unit 122 and a second image showing the first terminal T51 that was acquired by the second acquisition unit 121 are transmitted to the relative position orientation information calculating unit 222 via the communications unit 231.

The relative position orientation information calculating unit 222 uses the second position orientation information (Mv2(s)) and the second image information that were described above, calculates the relative position orientation information (M12(s) in FIG. 1) for the first terminal T51 and the second terminal T52, and outputs relative position orientation information to the second position orientation information correcting unit 223.

The second position orientation information correcting unit 223 receives the above described relative position orientation information M12(s), the first position orientation information Mw1(s) that was calculated by the first position orientation information calculating unit 113, and the second position orientation information Mv2(s) that was received via the communications unit 231.

In addition, the relative position orientation information (Mwv in FIG. 1) for between the first reference coordinate system X31 and the second reference coordinate system X32 is calculated based on the relative position orientation information M12(s), the first position orientation information Mw1(s), and the second position orientation information Mv2(s).

In addition, the above-described relative position orientation information Mwv is transmitted from the first terminal T51 to the second terminal T52 via the communications unit 231.

FIG. 6 is a flowchart showing a processing example of an information processing method that uses the information processing system of the Second Embodiment. Note that the processes for each step of the flowchart in FIG. 6 are performed in order by CPUs and the like serving as computers that have been internally provided to both the first terminal and the second terminal executing a computer program that has been stored on a memory.

Step S610 is processing that is executed in the first terminal T51, and step S620 is processing that is executed in the second terminal T52. The processing steps that are the same as the processing steps in the First Embodiment are notated using the same numbers, and explanations thereof will be omitted.

Step S2201 is executed in a case in which it has been determined during step S1204 that the corrected second position orientation information has not been received. During step S2201, second position orientation information that has been calculated by the second position orientation information calculating unit 122, and the second image information showing the first terminal T51 that was acquired by the second acquisition unit 121 are transmitted to the first terminal via the communications unit 231.

That is, the communications unit transmits the second image information that has been acquired by the second acquisition unit and the second position orientation information from the second terminal to the first terminal. If this has been transmitted, the processing transitions to S2202.

During step S2202, the corrected second position orientation information is received. That is, the relative position orientation information Mwv for between the first reference coordinate system X31 and the second reference coordinate system X32 that has been calculated by the second position orientation information correcting unit 223 is received and stored via the communications unit 231.

Note that in the same manner as in the First Embodiment, during step S1209, the second position orientation information calculating unit 122 executes the calculation for the Formula 1 by using the relative position orientation information (Mwv) for between the reference coordinate systems, and calculates the second position orientation information (Mw2(t)) corresponding to the first reference coordinate system X31.

During step S2101, it is determined whether or not the second image and the second position orientation information were received. That is, it is confirmed whether or not the data that was transmitted during step S2201 has been able to be received by the first terminal T51. If this has been received, the processing proceeds to step S2102, and if this has not been received, the processing returns to step S1106.

During step S2102, the relative position orientation information M12(s) for the first terminal T51 and the second terminal T52 during the time s is calculated. That is, the second position orientation information correcting unit 223 uses the second image, the second position orientation information, and the shape model for the first terminal T51 that is stored by the storage unit, which is not shown, that has been built into the first terminal T51, and calculates the above-described relative position orientation information M12(s).

That is, the relative position orientation information calculating unit calculates the relative position orientation information by using the second image information and the second position orientation information that have been received by the communications unit and the shape model of the first terminal that is stored by the first terminal.

The calculation method is the same as the method that was explained during step S1205 for the First Embodiment. Note that in the present embodiment, as was explained in the First Embodiment, it is not necessary for the second terminal T52 to store the shape model for the first terminal T51, which is a separate terminal, and it is sufficient if the first terminal T51 stores the shape model for the first terminal T51.

During step S2103, the second position orientation information is corrected. That is, the relative position orientation information (Mwv) for the first reference coordinate system X31 and the second reference coordinate system X32 is calculated by the second position orientation information calculating unit 223.

That is, the relative position orientation information (Mwv) is calculated from the Formula 2 using the relative position orientation information M12(s) for the first terminal T51 and the second terminal T52, the second position orientation information Mv2(s), and the first position orientation information Mw1(s).

After this, during step S2104, the second position orientation information that has been corrected is transmitted. That is, the above-described relative position orientation information Mwv, is transmitted to the second terminal via the communications unit 231. In this manner, in the present embodiment, the communications unit transmits the position orientation information that has been corrected by the second position orientation information correcting unit to the second terminal from the first terminal. After this, the processing transitions to step S1106.

In this manner, in the present embodiment, the image of the first terminal that has been captured by the second terminal, and the position orientation information that has been calculated by the second terminal are transmitted to the first terminal, and the relative position orientation information (Mwv) for the first reference coordinate system X31 and the second reference coordinate system X32 is calculated in the first terminal.

By doing so, it is sufficient if each terminal stores the shape model for itself, and communication of the shape models such as that which was explained in the variation examples for the First Embodiment is not necessary even if the terminals have different shapes. In addition, even if the shapes for two terminals do not match, it is possible to calculate the relative position orientation for between these terminals.

That is, it is possible to calculate the relative position orientation information (Mwv) for the first reference coordinate system X31 and the second reference coordinate system X32. In addition, it is possible to realize position orientation calculation in a standard reference coordinate system even for different terminals, and it is possible to display a virtual object in the same position in the physical space in a plurality of terminals.

### Variation Examples for the Second Embodiment

In the Second Embodiment, the relative position orientation information Mwv for the first reference coordinate system X31 and the second reference coordinate system X32 were calculated in the first terminal T51. However, up until the relative position orientation information M12(s) for the first terminal and the second terminal may also be calculated in the first terminal T51, and the relative position orientation for among the reference coordinate systems may also be calculated in the second terminal T52.

That is, the relative position orientation information M12(s) for the first reference terminal T51 and the second reference terminal T52 is transmitted to the second terminal T52 from the first terminal T51 via the communications unit 131. By doing so, the calculation load in the first terminal is decreased. In particular, in a case in which matching a plurality of terminals to the reference coordinate system for the first terminal is being attempted, it is possible to reduce the processing amount in the first terminal T51.

In addition, the communications contents for the communications unit 231 are not limited to the position orientation information, and the communications unit 231 may also transmit other information if it is information that is necessary in order to standardize the reference coordinate systems. For example, a camera parameter for the first image capturing apparatus 100 may also be transmitted from the first terminal T51 to the second terminal T52.

The above-described camera parameter includes parameters that indicate the focal distance, optical center, lens distortion, and the like for the camera. By doing so, it is possible to calculate the relative position orientation information (M12(s)) by using a suitable parameter for the camera that has performed the image capturing, and it is possible to make the reference coordinate systems match with a higher degree of precision.

In addition, the second acquisition unit 121 may also correct the second image information so as to standardize the camera parameters for the first image capturing apparatus 110 and the second image capturing apparatus 120. The standardization of the camera parameters may also use, for example, the well-known method that is disclosed in Japanese Unexamined Patent Application, First Publication No. 2022-11818. Note that, the communications unit 231 may also perform transmission and reception of the standardized camera parameter in advance such that each terminal is able to use the standardized camera parameter.

### Third Embodiment

In the First Embodiment and the Second Embodiment, configurations were explained in which information for standardizing reference coordinate systems between different terminals was transmitted and received. In the Third Embodiment, a configuration will be explained in which individual terminals identify different terminals, and perform pairing and unpairing of these different terminals.

FIG. 7 is a functional block diagram showing a configurational example of an information processing system of the Third Embodiment. Configurations that are the same as the configurations in the First Embodiment are notated with the same numbers, and explanations thereof will be omitted. An information processing system 3 comprises a first terminal T71 and a second terminal T72.

The differences from the First Embodiment are the point that a first terminal identification unit 311, a first display unit 312, a second terminal identification unit 321, and a second display unit 322 are added, and the point that the information that is transmitted and received by a communications unit 331 changes.

In this context, the first terminal identification unit 311 functions as a first terminal identification unit configured to identify the first terminal. In addition, the first display unit 312 and the second display unit 322 function as display units.

There are communications units 331 built into the first terminal T71 and the second terminal T72, and in addition to the information that is transmitted and received by the communications unit 131 that was explained in the First Embodiment, the following information is also transmitted and received by the communications unit 331.

That is, the information that is transmitted and received by the communications unit 131 includes identification information for the first terminal T71 to specify the second terminal T72, which is input and output by the first terminal identification unit 311 and the second terminal identification unit 321.

In addition, the information that is transmitted and received by the communications unit 131 includes pairing information relating to pairing requests for pairing the first terminal T71 and the second terminal T72, unpairing requests, and approval and denial of these requests. In addition, the information that is transmitted and received by the communications unit 331 also includes 3D contents (virtual objects) that will be displayed by the first display unit 312 and the second display unit 322.

The first terminal identification unit 311 outputs, as the first identification information, the first position orientation information Mw1(t) for the first terminal T71, an identification ID (a terminal number, a user name, and the like), and pairing information to the other terminals (the second terminal T72) via the communications unit 331.

The communications unit 331 transmits this information to the second terminal T72 via a wireless network. In addition, the first terminal identification unit 311 inputs second identification information that will be explained below via the communications unit 331, determines approval and denial relating to pairing included in the second identification information, and returns this to the second terminal T72 via the communications unit 331 via a wireless network.

The first display unit 312 displays to the user the 3D contents that are stored on the storage unit, which is not shown, of the first terminal T71 and the second position orientation information Mw2(t) in the reference coordinate system for the second terminal T72 that has been input via the communications unit 331. In addition, the first display unit 312 displays information (pairing information) relating to approval for pairing.

Variations for the display contents for the UI will be explained in detail in the variation example 3-1 and the variation example 3-2 for the Third Embodiment. In addition, the 3D contents that were described above are transmitted to the second terminal T72 via the communications unit 331.

The second terminal identification unit 321 outputs the second position orientation information Mw2(t) in the first reference coordinate system X31, and pairing information for the identification ID (terminal number, user name, and the like) to another terminal (the first terminal T71) via the communications unit 331. The communications unit 331 inputs this information into the first terminal identification unit 311 via a wireless network.

The second display unit 322 displays to the user the 3D contents that were acquired from the first terminal T71 via the communications unit 331, as well as the first position orientation information Mw1(t) and information (pairing information) relating to approval for pairing that were input via the communications unit 331. Variations for the display contents for the UI will be explained in detail in the variation examples 3-1, and variation examples 3-2.

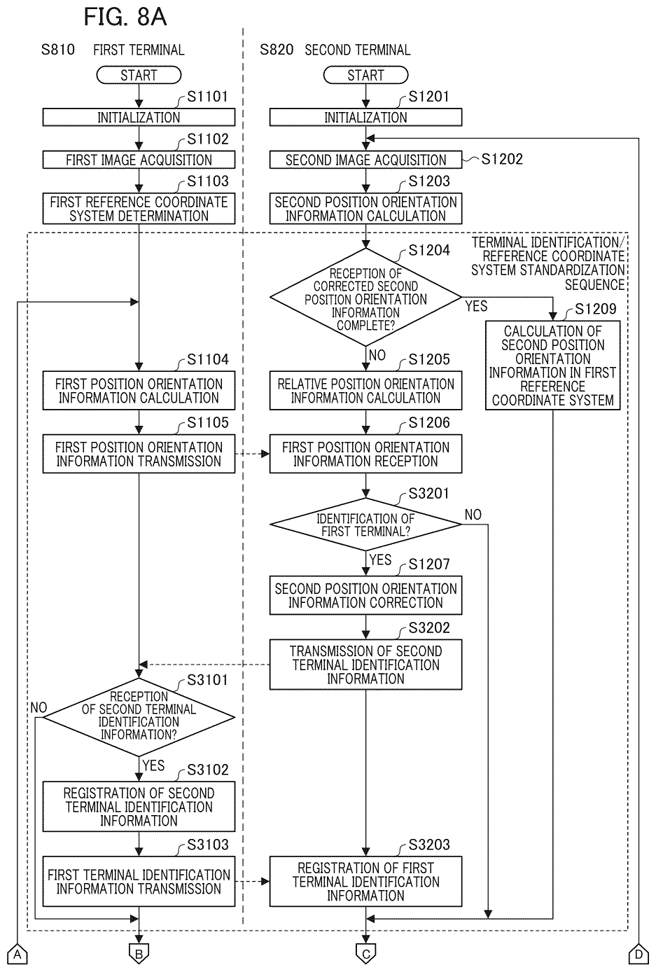

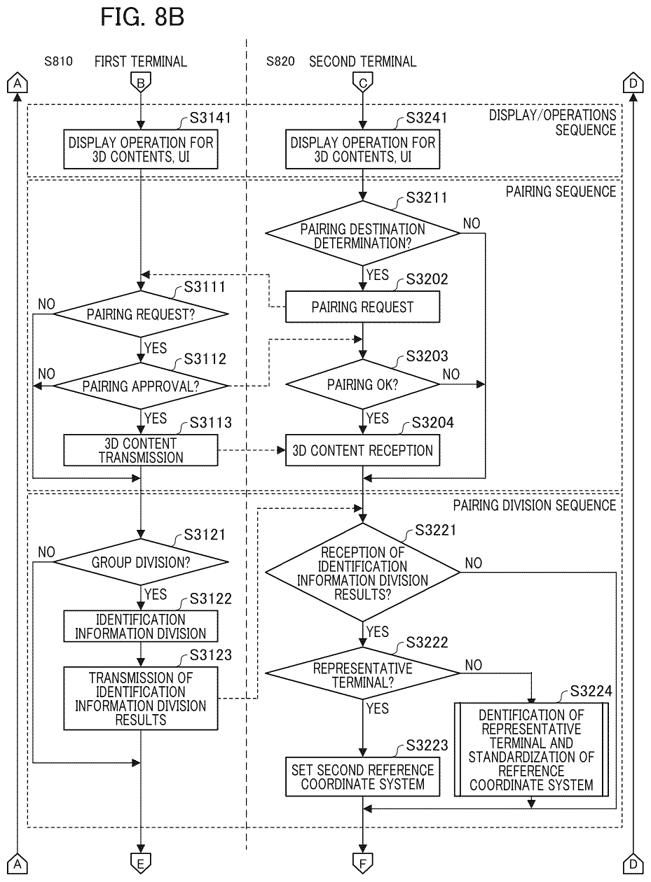

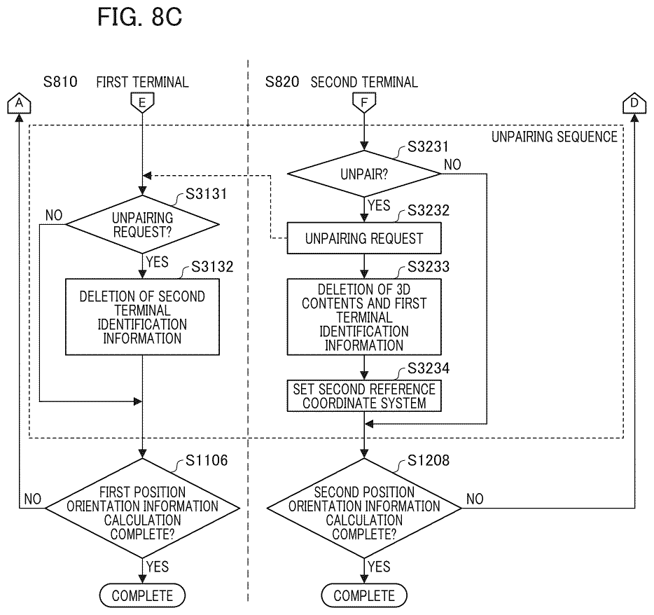

FIG. 8A is a flowchart showing a processing example for an information processing apparatus using the information processing system of the Third Embodiment, FIG. 8B is a flowchart showing a continuation of FIG. 8A, and FIG. 8C is a flowchart showing a continuation of FIG. 8B.

Note that the processes for each step of the flowcharts 8A to 8C are performed in order by CPUs and the like, which serve as computers and have been internally provided to the first terminal and the second terminal, executing a computer program that has been stored on a memory.

Step S810 is processing that is executed in the first terminal T71, and step S820 is processing that is executed in the second terminal T72. The processing steps that are the same as those in the First Embodiment are notated with the same numbers, and explanations thereof will be omitted.

Step S3101 to step S3103 is processing in which the first terminal T71 identifies the target, and step S3201 to step S3203 is processing in which the second terminal T72 identifies the target, and these are steps for standardizing the reference coordinate systems. In this manner, in the Third Embodiment, in addition to the processing steps for the First Embodiment, steps for the terminals to identify each other are added.

During step S3201, the second terminal identification unit 321 uses the first position orientation information Mw1(t) for the first terminal T71 that has been input by the communications unit 331 and determines whether or not the first terminal T71 has been identified. That is, it is identified whether or not the first terminal T71 appears in the first image information in the predicated position.

The predicated position is calculated by using the following Formula 3. That is, the first position orientation information Mw1(t) and the second position orientation information Mw2(t) for the first terminal in the first reference coordinate system X31 are used, and the position of the second terminal in relation to the first terminal (that is, the relative position orientation information M21(t)) is calculated using the following Formula 3.

$${M}_{21 ( t )} = {M}_{w 2 ( t )}^{- 1} {M}_{w 1 ( t )} \qquad Formula 3$$

If the first terminal T71 is shown in the predicted position, it is determined that the first terminal T71 has been identified, the processing transitions to step S1207, and the second position orientation information is corrected. If this is not the case, the processing transitions to step S3241.

During step S3202, the identification information for the second terminal T72 is transmitted. That is, the second terminal identification unit 321 transmits to the first information terminal T71, as the identification information for the second terminal T72, the second position orientation information Mw2(t) and the identification ID for the first terminal in the reference coordinate system via the communications unit 331. If this is transmitted, the processing transitions to step S3203.

During step S3203, the identification information for the first terminal T71 is registered. That is, the second terminal identification unit 321 inputs the identification information for the first terminal T71 that was received via the communications unit 331 from the first terminal T71. In addition, this identification information for the first terminal T71 is registered by being stored on the storage unit that is not shown, and the processing transitions to step S3241.

In contrast, during step S3101, the first terminal identification unit 311 determines whether or not the identification information for the second terminal T72 has been received via the communications unit 331. If this has been received, the processing proceeds to step S3102, and if this is not the case, the processing transitions to step S3141 of FIG. 8B.

During step S3102, the first terminal identification unit 311 registers the identification information for the second terminal T72 on the storage unit that is not shown, and the processing transitions to step S3103.

During step S3103, the first terminal identification unit 311 transmits the identification information for the first terminal T71 to the second terminal T72 via the communications unit 331.

Step S3141 and step S3241 of FIG. 8B are a display/operation sequence for displaying 3D contents and a UI on the first terminal T71 and the second terminal T72, and operating the UI. That is, during step S3141, the first display unit 312 displays the 3D contents, the identification information for the second terminal T72, and each type of UI on the first image information, and receives operation inputs.

During the superimposition of the 3D contents, first, the 3D contents are disposed on the first reference coordinate system X31. Next, the 3D contents as seen from the point of view of the first position orientation information are rendered by using the first position orientation information (Mw1(t)) m and this is synthesized on the first image information.

During the superimposition of the identification information for the second terminal T72, the second position orientation information Mw2(t) in the first reference coordinate system X31 is used, and the position of the second terminal relating to the first terminal (that is, the relative position orientation information M12(t)) is calculated using the following Formula 4. In addition, the rendering position is determined, and rendering is performed.

$${M}_{12 ( t )} = {M}_{w 1 ( t )}^{- 1} {M}_{w 2 ( t )} \qquad Formula 4$$

The UI displays a terminal name for which a pairing request, which will be described below, has been made, and an approval button therefor. In addition, UI operations from the user are received and input. If this series of processing is completed, the processing transitions to step S3111.

In contrast, during step S3241, the second display unit 322 displays the 3D contents, identification information for the first terminal T71, and each type of UI on the second image information, and receives operation inputs. During the superimposition of the 3D contents, first, the 3D contents are superimposed on the first reference coordinate system X31.

Next, the 3D contents as seen from the second position orientation information are rendered by using the second position orientation information Mw2(t) in the first reference coordinate system X31, and this is synthesized on the second image information.

During the superimposition of the identification information for the first terminal T71, the second position orientation information Mw2(t) in the first reference coordinate system X31 is used and the position of the second terminal in relation to the first terminal (that is, the relative position orientation information M21) is calculated by using the Formula 3. In addition, the rendering position is determined, and rendering is performed.

The UI displays the terminal name for which a pairing request, which will be explained below, is performed, and a selection button for a terminal. In addition, UI operations are received from the user and input. If this series of processing is completed, the processing transitions to step S3211.

Step S3111 to step S3113 and step S3211 to step S3204 are a group of steps for pairing the first terminal and the second terminal, that is, for approving the experience of the same 3D contents after having standardized the reference coordinate system.

During step S3211, it is determined whether or not a pairing destination has been determined. That is, the second terminal identification unit 321 determines whether or not to perform pairing for the first terminal T71 and the second terminal T72, that is, whether or not the same 3D contents will be experienced after having standardized the reference coordinate system.

The second terminal identification unit 321 determines whether or not the user has selected the terminal with which pairing will be performed, that is, the first terminal T71, on the UI that was displayed on the display unit 322 during step S3241. If this is selected, the processing proceeds to step S3202, and if this is not the case, the processing transitions to step S3221.

During step S3202, the second terminal identification unit 321 transmits a pairing request to the first terminal T71 via the communications unit 331. If this has been transmitted, the processing transitions to step S3203.

During step S3203, it is determined whether or not OK has been selected for the pairing. That is, the second terminal identification unit 321 receives whether or not the first terminal T71 has approved the pairing via the communications unit 331. If the pairing has been approved, the processing transitions to S3204, and if this is not the case, the processing transitions to step S3221.

During step S3204, the second terminal identification unit 321 receives the 3D contents that are used by the first terminal T71 via the communications unit 331. The 3D contents that have been received are stored on the storage unit that is not shown, and the processing transitions to step S3221.

In contrast, during step S3111, it is determined whether or not the pairing request has been received. That is, the first terminal identification unit 311 determines whether or not the pairing request for the first terminal T71 has been received via the communications unit 331. If the pairing request has been received, the processing proceeds to step S3112, and if this is not the case, the processing transitions to step S3121.

During step S3112, the first terminal identification unit 311 determines whether or not the pairing has been approved. Specifically, the pairing approval results that were input by the user on the UI that was displayed by the first display unit 312 during step S3141 are transmitted to the second terminal T72 via the communications unit 331. In addition, if the pairing has been approved, the processing proceeds to step S3113, and if this is not the case, the processing transitions to step S3121.

During step S3113, the first terminal identification unit 311 transmits the 3D contents that are stored on the storage unit that is not shown to the second terminal T72 via the communications unit 331. If this is transmitted, the processing transitions to step S3121.

Step S3121 to step S3123, and step S3221 to step S3224 are a pairing division sequence for dividing a plurality of terminals that have been paired into groups.

That is, during the pairing division sequence, the group of terminals for which the reference coordinate systems have been standardized is divided into a plurality of groups. Note that although in the present embodiment, an example is given of a configuration in which there are two terminals, it is also possible to realize the present disclosure using the same configuration and separating three or more terminals into two groups.

During step S3121, it is determined whether or not to perform the group division. That is, the first terminal identification unit 311 determines whether or not a terminal that will be divided into a group has been selected from among a list of terminals that have been paired. If there is a terminal that the user has selected as the group division target on the UI that has been displayed on the first display unit 312, the processing proceeds to step S3122, and if this is not the case, the processing transitions to step S3131.

During step S3122, the identification information is divided. That is, the first terminal identification unit 311 lists the terminal IDs that have been selected by the user, and from among these selects, by using a random number, a terminal to newly set the reference coordinates to as the representative terminal. In the present embodiment, it is assumed that the second terminal T72 has been selected as the representative terminal. If this processing is completed, the processing transitions to step S3123.

During step S3123, the identification information division results are transmitted. That is, as the identification information division results, the first terminal identification unit 311 transmits the list and the identification information for the representative terminal to the terminals that were listed during step S3122 via the communications unit.

In contrast, during step S3221, the second terminal identification unit 321 determines whether or not the identification information division results have been received via the communications unit 331. If the results have been received, the processing proceeds to step S3222, and if this is not the case, the processing transitions to step S3231 of FIG. 8C.

During step S3222, the second terminal identification unit 321 determines whether or not the second terminal T72 is the representative terminal based on the identification information division results that were received during step S3221. If it is determined that the second terminal T72 is the representative terminal, the processing proceeds to step S3223, and if this is not the case, the processing transitions to step S3224.

During step S3223, the second position orientation information calculating unit 122 calculates and sets the second reference coordinate system X32 in the second terminal T72 as was described in the First Embodiment.

In addition, although the explanation will be omitted in the present embodiment, if the list includes a plurality of terminals, the processing flow that is executed by the first terminal T71 is operated, and processing is executed to standardize the second reference coordinate system X32 to these terminals, and to receive pairing. In addition, if the second reference coordinate system X32 is calculated, the processing transitions to step S3231 of FIG. 8C.

Note that during step S3224, the second terminal identification unit 321 identifies the representative terminal that is included in the list, and standardizes the reference coordinate systems. In this processing, all that changes is the target terminal in the sequence for terminal identification/reference coordinate system standardization that has been explained, and therefore, an explanation thereof will be omitted. If the processing for step S3224 is executed, the processing transitions to step S3231 of FIG. 8C.

During step S3231, the second terminal identification unit 321 determines whether or not to unpair the terminals that are paired. Specifically, in a case in which the user has input an unpairing operation on the UI that has been displayed on the second display unit 322, the processing proceeds to step S3232, and if this is not the case, and in addition if there are no terminals for which pairing has been completed, the processing transitions to step S1208.

During step S3232, the second terminal identification unit 321 transmits the unpairing request to the first terminal T71 via the communications unit 331. If this has been transmitted, the processing transitions to step S3223.

During step S3223, the second terminal identification unit 321 deletes the 3D contents that were received from the first terminal T71 during step S3204 from the storage unit that is not shown, and also deletes the identification information for the first terminal that was received during step S3203. If these have been deleted, the processing proceeds to step S3234.

During step S3234, the second reference coordinate system is set. That is, the second position orientation information calculating unit 122 calculates the reference coordinate system in the second terminal T72 as was explained in the First Embodiment. If this calculation is completed, the processing transitions to step S1208.

In contrast, during step S3131, the first terminal identification unit 311 determines whether or not the unpairing request that was transmitted from the second terminal T72 via the communications unit 331 has been received. If this has been received, the processing proceeds to step S3132, and if this is not the case, the processing transitions to step S1106.

During step S3132, the first terminal identification unit 311 deletes the identification information for the second terminal T72 that was registered during step S3102 from the storage unit, which is not shown. If this has been deleted, the processing transitions to step S1106.

In this manner, the information for performing identification, pairing, unpairing, and division of pairing (groups) for each terminal is communicated between the first terminal and the second terminal. It is thereby possible to identify a plurality of terminals, determine which terminal to share 3D contents with, to make groups, and to divide the terminals into these groups, and delete them, and it is also possible to display the virtual object in the same position in the physical space for the desired terminals.

### Variation Example 3-1 for the Third Embodiment

In the Third Embodiment, although the processing consisted of a terminal identification/reference coordinate system standardization sequence, a display/operation sequence, a pairing sequence, a pairing division sequence, and an unpairing sequence, these may also be selected according to the configuration to be implemented. That is, all of these functions are not essential elements of the present disclosure, just a portion of these functions may also be executed, and the order is also not limited to the order that was described above.

In addition, although the processing for the 3D contents and the pairing was performed after having standardized the reference coordinate systems, this processing may also be executed before standardizing the reference coordinate systems. Furthermore, the order of whether or not to transmit and receive the 3D contents before the pairing processing may also be switched.

By doing so, the waiting time to receive the 3D contents is reduced in advance. In addition, a configuration such that the information for standardizing the reference coordinate systems and the 3D contents are transmitted after performing pairing can also be realized, and therefore, the privacy is increased by being able to display the 3D contents only to the desired party, and the like.

In addition, although in the Third Embodiment, the processing for standardizing the reference coordinate systems was performed using the method of the First Embodiment, the method for the Second Embodiment may also be executed. The configurations of the First Embodiment and the Second Embodiment may also be combined and used.

In addition, in the Third Embodiment, the representative terminal was selected using a random number at the time of the group division. However, as was explained in the First Embodiment, if the communications unit 331 transmits and receives the position orientation calculation precision information and the position orientation calculating stability information for each terminal, a terminal that calculates the position orientation information stably and with a high precision may also be selected as the representative terminal. By doing so, it is possible to standardize the reference coordinate systems with a terminal that performs calculations with a higher degree of precision as the reference.

In addition, the second terminal identification unit 321 may also identify the terminals by using position orientation information in a time series. That is, identification may also be performed by using trace information in which the terminal moves.

Specifically, the first position orientation information Mw1(t) that was calculated by the first terminal and the position orientation Mv1(t) for the first terminal for reference for the second terminal that was calculated by the second terminal are calculated at a plurality of times and made the trace information (Mw1(t) is made first trace information, and Mv1(t) is made second trace information).

That is, the first position orientation information calculating unit calculates the first trace information for the first terminal by using the first position orientation information that was calculated between a predetermined time period.

In addition, the second position orientation information that was calculated by the second position orientation calculating unit between a predetermined time period and the relative position orientation that was calculated by the relative position orientation information calculating unit between a predetermined time period are used, and the second trace information for the first terminal, which is a trace of the first terminal for reference for the second terminal, is calculated. In addition, it may also be made such that the first terminal identification unit identifies the first terminal in a case in which the first trace information and the second trace information conform with each other.

That is, it may also be determined that the first terminal has been identified if the residual from when rigid transformation was performed so as to make the positions for the same time of these pieces of trace information match is smaller than a predetermined value. In addition, this is not limited to the position, and the determination may also be made using just the posture, and the residuals for both the position and the posture. By doing so, even if a terminal that has a similar shape to the first terminal is shown in the second image information, it is possible to identify this terminal as a different terminal.

Furthermore, the first terminal identification unit 311 may also use the first image information, identify the second terminal T72, and calculate the relative position orientation information M12(t) for between terminals. By doing so, it is possible for the first terminal T71 and the second terminal T72 to identify each other, and it is possible for the terminals to identify each other with less errors. It is therefore possible to more robustly standardize the reference coordinate systems.

In addition, this may also be made a configuration in which after having standardized the reference coordinate systems once, the reference coordinate systems are standardized again. In this case, the processing for standardizing the reference coordinate systems that was shown in the Third Embodiment may be executed again, and calculations may also be performed again such that the results for the first and second standardization processing are integrated (for example, weighted integration, and the like).

In addition, this may also be a configuration in which the first reference coordinate system X31 for the first terminal and the reference coordinate system that has been corrected and is being used in the second terminal are displayed on the UI, the user uses a correction amount that has been revised so as to make these match, and calculation is performed again.

In addition, it may also be confirmed at an arbitrary timing that the reference coordinate systems are not out of alignment. Specifically, the relative position orientation information M12(t) for between the first terminal T71 and the second terminal T72 may also be calculated again. In addition, the first position orientation information Mw1(t) that was calculated by the first terminal and the relative position orientation information m12(t) can be used, and this can be determined based on the size of a difference with a position orientation M′w1(t) that has been calculated by using for example, the following Formula 5.

In addition, in order to perform this determination, this information may also be transmitted and received between the first terminal T71 and the second terminal T72 using the communications unit 331.

$${{M}^{′}}_{w 1 ( t )} = {M}_{w 2 ( t )} {M}_{12 ( t )}^{- 1} \qquad Formula 5$$

By doing so, in a case in which the reference coordinate systems have become un-aligned after having standardized the reference coordinate systems once, it is possible to standardize the reference coordinate systems with a higher degree of precision by performing the calculations again.

### Variation Example 3-2 for the Third Embodiment

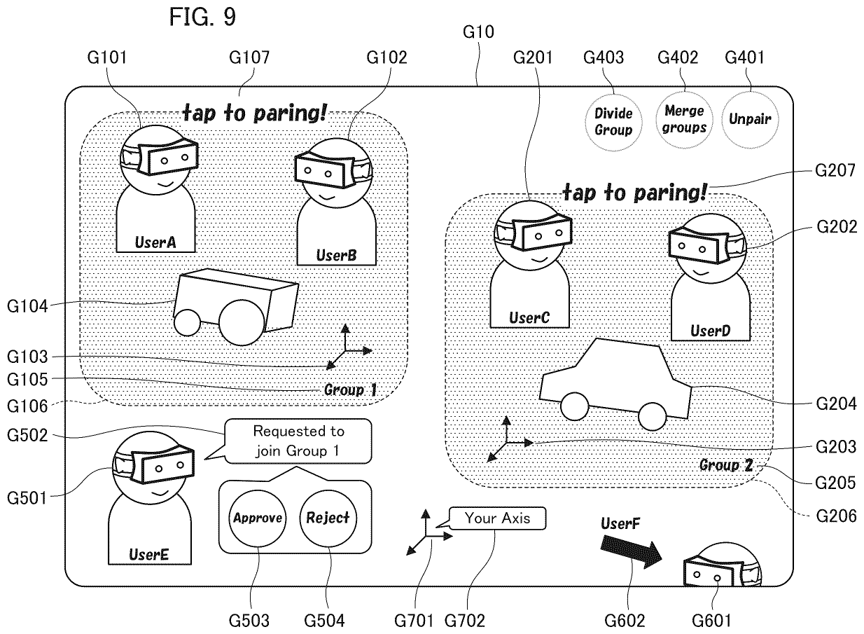

FIG. 9 is a diagram showing an example of a GUI that is displayed by the information processing system of the Third Embodiment, wherein G10 is an example of a GUI that is displayed by the first display unit 312 and the second display unit 322. G101 and G102 are users belong to a Group1, and the user names, which are the identification IDs (UserA, and UserB) are superimposed and displayed.

In addition, an example is shown in which terminals that are being used by a user that belongs to the Group1 are used by standardizing G103, which is the reference coordinate system, and the standard 3D contents G104 are displayed.

In addition, G105 is the group name for a group that has been paired (in this context, the Group1), and G106 displays a box for identifying which terminals and users belong to the Group1. G107 indicates to the user that in order to participate in this group, pairing should be performed by tapping this box.

G201 and G202 are users that belong to the Group2, and the user names, which are the identification IDs (UserC and UserD) are superimposed and displayed. In addition, an example is shown in which the terminals that are used by users who belong to a Group2 are used by standardizing G203, which is the reference coordinate system, and the standard 3D contents G204 are displayed.

In addition, G205 is a group name for which pairing has been performed (in this context, the Group2), and G206 displays a box for identifying which terminals and users belong to the Group 2. G207 indicates to the user that in order to participate in this group, pairing should be performed by tapping this box.

Note that G103 and G104 are acquired by standardizing the reference coordinate systems for the terminals that are being used by G101, and G102, as well as receiving the 3D contents using the method that was explained in the Third Embodiment.

G401 is a button for unpairing a terminal from a terminal with which it has been paired. G402 is a button for linking a plurality of groups. After this button has been tapped, if G106 and G206 are tapped, these become one group by standardizing the reference coordinate systems for G103 and G203.

G403 is a button for dividing groups. After this button has been tapped, if for example, G101 is tapped, G101 is separated into a different group from the Group1.

G501 shows a user (the userE) that is participating in the Group1. G502 displays a message stating that the user would like to participate in the Group1. G503 and G504 are buttons that select whether or not to approve participation (that is, pairing) for each group. If G503 is pressed, then the participation is approved, and if G504 is selected, the participation is denied.

In this manner, in the present embodiment, the display unit displays the terminals that share a coordinate system from among the plurality of terminals that have been identified by the first terminal identification unit so as to be selectable by the user.

G601 indicates a user (the userF) of which a portion is hidden from the screen. A denotation (arrow) G602 is shown to the user so as to change the orientation of the camera so as to be able to calculate the relative position orientations between the terminals in order to standardize the reference coordinate systems between the terminals.

G701 is the reference coordinate system for the terminals used by the user displaying the present GUI 10, and a message to this effect is displayed on G702. For example, in a case in which the reference coordinate systems have been made to match the reference coordinate system for G103, if the reference coordinate systems are out of alignment, it is possible to adjust the reference coordinate system by dragging G701. Note that even if G701 is not the reference coordinate system, it is sufficient as long as this is an indices that allows the user to identify the unalignment, and this may also be CG, an arrow, and the like.

In this manner, in the display apparatus of the present embodiment, the second position orientation information that has been corrected is used, the position orientation information for the second terminal is superimposed and displayed on the first image information, and the position orientation information for the first terminal is superimposed and displayed on the second image information.

In addition, in the present embodiment, a UI that performs the identification, pairing, unpairing, and division of pairing (grouping) of each terminal and a UI that adjusts the reference coordinate system are displayed. By doing so, the user is able to easily execute each of these operations, and it is possible to display the virtual object in the same position in the physical space as a predetermined terminal without any complex operations.

Note that, although in the above-described embodiments, an example was explained in which each terminal includes an information processing system, at least a portion of the functions of the information processing system may also be provided to a server that is external from the terminal. In addition, although an example has been explained in which the terminal was a HMD, any type of terminal may be used as long as it has a camera that captures image information and a function that is able to perform information processing.

In addition, the terminal may also be, for example, a smartphone that has a camera, and may also be a PC that has been equipped with a camera. Conversely, this may also be an autonomous movable apparatus such as an AGV and the like that has a camera. In addition, the types of each terminal may also be different from each other.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2024-196502, filed on Nov. 11, 2024, which is hereby incorporated by reference herein in its entirety.

What is claimed is:

1. An information processing system configured to align a coordinate system that is shared between a plurality of devices, the information processing system comprising:
at least one processor, and a memory coupled to the at least one processor, the memory storing instructions that, when executed by the at least one processor, cause the at least one processor to:
perform communications between a first device and a second device;
acquire first image information from a first image capturing apparatus that has been provided to the first device;
determine a first reference coordinate system in the first device based on the first image information;
calculate first position orientation information indicating a position & orientation of the first device by using the first image information and the first reference coordinate system;
acquire second image information from a second image capturing apparatus that has been provided to the second device;
calculate second position orientation information indicating a position & orientation of the second device by using the second image information;
calculate relative position orientation information indicating a relative position orientation of the first device and the second device based on the second image information and the second position orientation information; and
use the first position orientation information, the second position orientation information, and the relative position orientation information, and align the second position orientation information with the first reference coordinate system.

2. The information processing system according to claim 1, wherein during the communications, the first position orientation information is transmitted to the second device from the first device, and the relative position orientation information is calculated by using the first position orientation information that has been received via the communications.

3. The information processing system according to claim 2, wherein during the communications, a shape model for the first device that is stored by the first device is further transmitted from the first device to the second device, and the relative position orientation information is calculated by performing model fitting by using the shape model for the first device that has been received via the communications.

4. The information processing system according to claim 1, wherein
during the communications, the second image information and the second position orientation information are transmitted from the second device to the first device;
the relative position orientation is calculated by using the second image information and the second position orientation information that have been received via the communications, and a shape model of the first device that is stored by the first device; and
the position orientation information that has been corrected during correction of the second position orientation information is further transmitted to the second device from the first device.

5. The information processing system according to claim 1, wherein during the communications, a time for the first device and a time for the second device are synchronized by further transmitting time information for the first device and the second device;
an image capturing time at which the first image information was image captured is associated with the first image capturing information, and an image capturing time at which the second image information was image captured is associated with the second image capturing information; and
a time at which the first image information was image captured and a time at which the second image information was image captured are associated and stored.

6. The image processing apparatus according to claim 1, wherein:
the first image information and the second image information have been image captured at a plurality of times, and the first position orientation information, the second position orientation information, and the relative position orientation information are calculated for images of each time by using the first image information and the second image information that have been image captured at a plurality of times; and
the second position orientation information is aligned with the first reference coordinate system by selecting the first position orientation information, the second position orientation information, and the relative position orientation information for which the difference in image capturing times that have been associated with the first position orientation information, the second position orientation information, and the relative position orientation information is at or below a predetermined value from among the first position orientation information, the second position orientation information, and the relative position orientation information that have been calculated for a plurality of times.

7. The information processing system according to claim 1, the memory storing further instructions that, when executed by the at least one processor, cause the at least one processor to:
further identify the first device.

8. The information processing system according to claim 7, wherein
during the communications, a shape model for the first device is further transmitted in order to identify the first device based on the second image information; and
the shape model for the first device is used, and the first device is identified by recognizing the first device from the second image information.

9. The information processing system according to claim 7, wherein
first trace information for the first device that has been calculated by using the first position orientation information that was calculated during a predetermined time period, and second trace information for the first device, which is a trace of the first device for reference for the second device that was calculated by using the second position orientation information and the relative position orientation information that were calculated during a predetermined time period are calculated; and
the first device is identified in a case in which the first trace information and the second trace information conform with each other.

10. The information processing apparatus according to claim 1, wherein,
the information processing apparatus further comprises a display apparatus configured to use the second posture information that has been corrected, and superimpose and display the position orientation information for the second device on the first image information, and superimpose and display the position orientation information for the first device on the second image information.

11. The information processing system according to claim 7, the memory storing further instructions that, when executed by the at least one processor, cause the at least one processor to:
display so as to be selectable by a user, from among a plurality of devices that have been identified, terminals having shared coordinate systems.

12. The information processing system according to claim 1, the memory storing further instructions that, when executed by the at least one processor, cause the at least one processor to:
further store map information for calculating the second position orientation information; and
when aligning the second position orientation information with the first reference coordinate system, perform aligning such that coordinates for each element of the map information become the first reference coordinate system.

13. An information processing method for aligning a shared coordinate system between a plurality of devices, the method comprising:
performing communications between a first device and a second device;
acquiring first image information from a first image capturing apparatus that has been provided to the first device;
determining a first reference coordinate system in the first device based on the first image information;
calculating first position orientation information indicating a position orientation of the first device by using the first image information and the first reference coordinate system;
acquiring second image information from a second image capturing apparatus that has been provided to the second device;
calculating second position orientation information indicating a position orientation of the second device by using the second image information;
calculating relative position orientation information indicating a relative position orientation of the first device and the second device based on the second image information and the second position orientation information; and
using the first position orientation information, the second position orientation information, and the relative position orientation information, and aligning the second position orientation information with the first reference coordinate system.

14. A non-transitory computer-readable storage medium configured to store a computer program comprising instructions for executing the following processes:
performing communications between a first device and a second device;
acquiring first image information from a first image capturing apparatus that has been provided to the first device;
determining a first reference coordinate system in the first device based on the first image information;
calculating first position orientation information indicating a position orientation of the first device by using the first image information and the first reference coordinate system;
acquiring second image information from a second image capturing apparatus that has been provided to the second device;
calculating second position orientation information indicating a position orientation of the second device by using the second image information;
calculating relative position orientation information indicating a relative position orientation of the first device and the second device based on the second image information and the second position orientation information; and
using the first position orientation information, the second position orientation information, and the relative position orientation information, and aligning the second position orientation information with the first reference coordinate system.
